(19) United States
(12) Patent Application Publication
(10) Pub. No.: US 2014/0260772 A1
(43) Pub. Date: Sep. 18, 2014

(54) LEVER GUARD AND HANDLEBAR EXTENDER FOR MOTORCYCLE HANDLEBAR AND METHOD OF INSTALLING THE SAME

(71) Applicant: Stéphane Dion, Granby (CA)

(72) Inventor: Stéphane Dion, Granby (CA)

(21) Appl. No.: 14/215,631

(22) Filed: Mar. 17, 2014

Related U.S. Application Data
(60) Provisional application No. 61/791,271, filed on Mar. 15, 2013.

(51) Int. Cl. B62K 21/12

(52) U.S. Cl. CPC B62K 21/125
USPC 74/551.8; 29/428

(57) ABSTRACT

The present document describes a lever guard and handlebar extender kit for a motorcycle having a handlebar and a lever mounted thereon. The handlebar comprises a hollow portion having an open end, a handlebar grip and a handlebar end cap mounted within the hollow portion and covering the open end. The kit comprises: a handlebar extender for replacing the handlebar end cap, the handlebar extender capable of adopting a plurality of positions between a retracted position and an extended position, any one of the plurality of positions providing an extension to the handlebar allowing displacement of the handlebar grip on the handlebar over the extension thereby providing additional space on the handlebar; and a lever guard for mounting to the handlebar using the additional space and, once mounted, the lever guard extending in front of the lever thereby providing substantial protection from objects coming toward the lever from the front.

### CROSS-REFERENCE TO RELATED APPLICATIONS

This application claims priority of U.S. provisional patent application No. 61/791,271, filed on Mar. 15, 2013, which is hereby incorporated by reference.

### BACKGROUND

(a) Field

The subject matter disclosed generally relates to accessories for motorcycles. More particularly, the subject matter relates to lever guards and handlebar extenders for motorcycle handlebars.

(b) Related Prior Art

In circumstances such as in motorcycle track racing, proximity between racers may be such that inadvertent physical contacts may occur. In some cases, contacts between a racer, or a part of a competing motorcycle, and a control lever mounted on the handlebar, such as a brake lever or a clutch lever, of another motorcycle may occur.

For instance, tragic accidents sometimes result from a brake lever being triggered which suddenly applies a braking effect to the front wheel and projects the rider or racer forwardly on the racing track with very high velocity.

Furthermore, the outward extremity of the brake lever may be hit in the forward direction. This may transfer a torque force to the handlebar, leading to a sudden deviation from the current direction and potentially creating an accident.

Additionally, recreational motorcyclists are often challenged by obstacles near the roads where they are motorcycling. For example, in some states in the United States, motorcyclists may be allowed to drive between cars at red lights. Thus, many accidents may occur annually while brake levers or clutch levers of motorcycles are triggered by external elements near the roads (i.e., rear view mirrors of cars parked on the sideways, tree branches, and the like, for instance).

It is known in the art to provide hand guards or shields to prevent discomfort or injuries to hands or wrists of motorcyclist caused by projected matters, cold winds or squeezing between the handlebar and the control lever. However, these devices generally present one or more of the following limitations and drawbacks.

They do not implement sufficient rigidity and strength to prevent severe impacts to the control lever. They do not prevent an external force from being transferred in the forward direction from a lever extremity or from the protecting device itself to the handlebar. They are designed for use on motocross cycles so that they present a shape and size that would cause interference with the careening of a street racing motorcycle when the handlebar is brought near to its maximal turning angle, which therefore prevents use for such an application.

Moreover, devices of the prior art are not intended to prevent a driver's wrist from being retained in a space usually extending between the brake lever, the master cylinder and the handlebar should the driver be projected forwardly over the motorcycle.

Moreover, it is usually a challenge to position a lever guard between the front brake master cylinder/switch and the grip/throttle slider for motorcyclists.

There is therefore a need for a handlebar extender, a lever guard, a handlebar extender kit to be easily mounted on the handlebar of a motorcycle. There is also a need for a method of installing a handlebar extender and a lever guard on a handlebar.

### SUMMARY

According to an embodiment, there is provided a lever guard and handlebar extender kit for a motorcycle having a handlebar and a lever mounted thereon, the handlebar comprising a hollow portion having an open end, a handlebar grip and a handlebar end cap mounted within the hollow portion and covering the open end, the kit comprising: a handlebar extender for replacing the handlebar end cap, the handlebar extender capable of adopting a plurality of positions between a retracted position and an extended position, any one of the plurality of positions providing an extension to the handlebar allowing displacement of the handlebar grip on the handlebar over the extension thereby providing additional space on the handlebar; and a lever guard for mounting to the handlebar using the additional space and, once mounted, the lever guard extending in front of the lever thereby providing substantial protection from objects coming toward the lever from the front.

According to an aspect, the handlebar further comprises an anchor installed within the hollow portion and wherein the handlebar extender comprises a bar end extension for adjustable attachment to the anchor.

According to an aspect, the bar end extension comprises: a main portion to be at least partially inserted within the hollow portion of the handlebar; and an lip portion extending from the main portion of the bar end extension and providing an abutment against which the handlebar grip will come into contact when displaced on the handlebar to cover the extension created by the handlebar extender.

According to an aspect, the handlebar extender further comprises a ring having a given length for installation between the anchor and the bar end extension, the given length corresponding to the extension, the ring thereby ensuring the extension that is required is respected.

According to an aspect, the main portion of the bar end extension comprise a cylindrical shape which matches a shape of the hollow portion of the handlebar.

According to an aspect, the handlebar extender further comprises a connector for attachment of the bar end extension to the anchor.

According to an aspect, at least one of the main portion and the lip portion are made of a rubber material.

According to an aspect, the extension has a length of about 15 mm.

According to an aspect, the lever guard comprises: a first arm segment having a first end and a second end, the first arm segment to be mounted on the handlebar at its first end, the first arm segment extending from the handlebar; and a second arm segment extending from the second end of the first arm segment in front of the lever, the second arm segment providing the substantial protection from objects coming toward the lever from the front.

According to an aspect, at least one of the first arm segment and the second arm segment comprise ribs on a surface thereof providing enhanced rigidity.

According to an aspect, the kit further comprises a shield member mounted on the second arm segment, thereby allowing adjustment of an effective length of the second arm segment.

According to an aspect, the second arm segment comprises at least one opening about a distal end thereof, the shield member comprises at least one corresponding opening, the kit further comprising at least one connector for removably attaching the shield member about the distal end of the second arm segment using the at least one opening and the at least one corresponding opening.

According to an aspect, the shield member defines a surface, the surface defining at least one of: a curved shape and at least one projection, thereby reducing possible deflections of the lever under pressure effects caused by one of: wind and a careening element.

According to an aspect, at least one of: the first arm segment, the second arm segment and the shield member is made from at least one of: a metallic material, a composite material, aerospace grade aluminum and a carbon fiber reinforced composite material.

According to an aspect, the lever guard further comprises at least one of: a mirror, a lamp, a camera, and a blinker mounted on at least one of: the first arm segment, the second arm segment and the shield member.

According to an aspect, the lever guard further comprises an articulated joint for articulably joining the first arm segment and the second arm segment, the articulated joint for at least one of: allowing the second arm segment to abut in a rest position to resist forces applied thereto in a direction facing the handlebar and enabling a displacement of the second arm segment relative to the first arm segment in a direction away from the handlebar.

According to an aspect, the lever guard further comprises a user adjustable stop member assembly for allowing adjustment of a space between the lever and the second arm segment.

According to an embodiment, there is provided a method for installing a lever guard on a motorcycle having a handlebar and a lever mounted thereon, the handlebar comprising a hollow portion having an open end and a handlebar grip, the method comprising: installing a handlebar extender within the hollow portion to create an extension to the handlebar; sliding the handlebar grip over the extension to create additional space on the handlebar; and installing the lever guard on the handlebar after the handlebar grip using the additional space.

According to an aspect, the method further comprises removing a handlebar end cap mounted within the hollow portion prior to installing the handlebar extender.

According to an aspect, the method further comprises moving other components installed on the handlebar prior to installing the lever guard.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a cross-sectional view of a handlebar in accordance with an embodiment, showing an exploded view of a handlebar extender;

FIG. 2 is a cross-sectional view of a handlebar in accordance with another embodiment, showing a handlebar extender in an extended position relative to the handlebar and a lever guard adjacent a front brake lever;

FIG. 3 is a perspective view of a lever guard mounted on a handlebar in accordance with another embodiment;

FIG. 4 is a front elevation view of a lever guard mounted on a handlebar which has a front brake lever in accordance with another embodiment;

FIG. 5 is a perspective view of a lever guard mounted on a handlebar in accordance with another embodiment;

FIG. 6A illustrates a handlebar extender in accordance with an embodiment;

FIG. 6B illustrates a handlebar extender in accordance with another embodiment; and

FIG. 6C illustrates a handlebar extender in accordance with yet another embodiment.

It will be noted that throughout the appended drawings, like features are identified by like reference numerals.

### DETAILED DESCRIPTION

In embodiments, there are disclosed lever guards, handlebar extenders for handlebars (i.e., such as bike, or motorcycle handlebars), lever guard and handlebar extender kits for handlebars (i.e., such as bike, or motorcycle handlebars) and methods of installing the same on handlebars (i.e., such as bike, or motorcycle handlebars).

Referring now to the drawings, and more particularly to FIGS. 1 to 5, there are shown lever guards 10 according to embodiments.

According to different embodiments, FIGS. 2-5 show a lever guard 10 adapted to be mounted on a handlebar 12 (i.e., such as bike, or motorcycle handlebars 12) of a motorcycle (not shown). As shown, the handlebar 12 has a lever 14 mounted on the handlebar 12 of the motorcycle. The handlebar 12 includes a hollow portion 16 which has an open end 18, a throttle slider 20, an anchor 22 which is mounted within the hollow portion 16 and a handlebar grip 24.

The lever guard 10 includes a first arm segment 26 which has a first end 28 and a second end 30. The first arm segment 26 is mounted (i.e., removably mounted) on the handlebar 12 at its first end 28. The first arm segment 26 extends upwardly and outwardly from the handlebar 12. The lever guard 10 further includes a second arm segment 32 which extends from the second end 30 of the first arm segment 26. According to an embodiment, the second arm segment 32 extends substantially perpendicularly from the second end 30 of the first arm segment 26. The first arm segment 26 and the second arm segment 32 are configured to provide, once installed on the handlebar 12, a protective space 34 between the second arm segment 32 and the lever 14 mounted on the handlebar 12.

According to an embodiment, the first arm segment 26, at its second end 30, includes a stop member assembly 72. The second end 30 of the first arm segment 26 is assembled to a proximal end 38 of the second arm segment 32 through an articulated joint 40.

It is to be noted that the first arm segment 26 and the second arm segment 32 may be connected or removably connected together using any suitable connectors (i.e., screws, and the like).

According to an embodiment, the lever guard 10 may further include a handlebar mounting device 42 at the first end 28 of the first arm segment 26 for providing a removable connection of the lever guard 10 to the handlebar 12. The handlebar mounting device 42 may include a lower jaw portion 44 which defines a semi-circular cavity for mating with a lower portion 46 of the handlebar 12. The lower jaw portion 44 is assembled to a top jaw portion 48 defining a complementary second cavity which uses any suitable connectors, such as, without limitation, tightening machine screws 50a and 50b, to provide a stable and rugged mounting of the lever guard 10 on the handlebar 12.

According to one embodiment, and as shown in FIGS. 2, 3 and 4, the lever guard 10 may further include a shield member 52 mounted at a distal end 54 of the second arm segment 32, thereby allowing adjustment of an effective length of the second arm segment 32.

According to one embodiment, the longitudinal position of the shield member 52 on the second arm segment 32 may be adjustable by connectors, such as, without limitation, sliding machine screws 56a and 56b, to a desired position into and along the slot 58 and tightening them to lock the shield member 52 in that position.

According to another embodiment, and still referring to FIGS. 2, 3 and 4, alternatively, a specific slot may be provided for each screw, which may increase rigidity and mechanical resistance of the shield member 52. Thus, the effective length of the second arm segment 32 may be adjusted so that the surface of the shield member 52 may be properly aligned with a distal extremity 60 of the lever 14 or control lever 14 (i.e., without limitation, a clutch lever, a brake lever and the like) (see FIG. 4) to prevent external objects or a careening element 62 (i.e., without limitation, another motorbike, a body part of another competitor, a tree branch, a car mirror and the like) from hitting or contacting the lever 14.

It is to be noted that a proper adjustment of the positioning of the shield member 52 may also be critical to prevent from exceeding the extremity of the lever 14, which would undesirably increase risks of interference with the careening element 62 within the external environment.

The shield member 52 may be configured according to different sizes and configurations for preventing impacts to the lever 14 and protecting the driver's hand from being impacted by external objects or a careening element 62 or squeezed between the lever 14 and the handlebar 12.

According to an embodiment, the surface of the shield member 52 may also be configured to reduce possible deflection of the brake lever 14 under the aerodynamic pressure effects caused by the wind when the motorcycle is being driven at racing speeds that can reach as high as 300 km/h. For example, the surface of the shield member 52 may be curved or may include outward projections such as to reduce air turbulence around the shield member 52 and the lever guard 10 in general.

It is also to be mentioned that the first arm segment 26 and second arm segment 32 may define a substantially lean profile to minimize the effect of the wind causing a repulsive force thereon, which is a function of the area and shape of the lever guard surface. Such a force at high speed may create undesirable torque on the handlebar 12 especially if the lever guard 10 is mounted on the brake lever side only.

According to an embodiment, and as best shown in FIG. 4, the second arm segment 32 may further define a first curvilinear intermediate portion 64 defining a concave recessed portion 66 in a direction opposite to the handlebar 12. The purpose of the concave recessed portion 66 is to prevent interference of the second arm segment 32 with a careening element 62 (i.e., on a street or racing motorcycle) when the handlebar 12 is being pivoted near its maximum angular position, moving the lever guard 10 dose to the careening element 62.

According to an embodiment, and still referring to FIG. 4, the second arm segment 32 may further define a second curvilinear intermediate portion 68 defining a second recessed portion opening 70 in the direction of the handlebar 12 to provide a clearance for the rider's hand between the lever 14 and the second arm segment 32.

According to an embodiment, the position of the second arm segment 32 and the resulting clearance may be adjusted through a user adjustable stop member assembly 72.

According to an embodiment, the user adjustable stop member assembly 72 may include a flange 74 defined at the second end 30 of the first arm segment 26. The flange 74 is provided with a threaded hole for receiving a threaded stop member 78, such as a machine screw, which may be lockable at a user selected depth in the threaded hole using a nut 80, to set the position of the seat 82 on which the proximal end 38 of the second arm segment 32 abuts in a rest position to resist forces applied thereto in the direction of the handlebar 12.

According to an embodiment, the articulated joint 40 is defined by mating fork shaped drilled ends 86 and 88 of first arm segment 26 and second arm segment 32 pivotally assembled about an axle 90. The articulated joint 40 is a single axis joint which enables displacement of the second arm segment 32 away from the user adjustable stop member assembly 72 in a direction opposite to the handlebar 12. A coil spring 92 is mounted in the articulated joint 40 to provide a biasing force holding the second arm segment 32 against the seat 82 of the user adjustable stop member assembly 72 in its rest position when no external force is applied thereto.

According to an embodiment, the second arm segment 32 may adopt different angular positions with respect to the first arm segment 26 under the action of a force applied in a direction opposite to the handlebar mounting device 42, and may resume into its rest position when the force is withdrawn. Thus, a twofold protection is provided: 1) the lever guard 10 prevents forces and impacts applied in the handlebar 12 direction from contacting the lever 14 and causing undesired operation of the lever 14 (i.e., brake lever or clutch lever) and 2) a force applied in the opposite direction causes the lever guard 10 to collapse forwardly thus preventing torque from being transferred to the handlebar 12 to interfere with the motorcycle steering operation.

According to an embodiment, the second arm segment 32 (with or without shield member 52) may also help in protecting the motorbike since it takes the hardest portion of the hit when the bike goes down and limits bike damages (i.e., damages on the front brake master cylinder 94, lever 14, gas tank (not shown) and the like).

The lever guard 10 associated with a spring-back collapsible lever further prevents hand and/or wrist injuries when the rider is being projected forwardly. It can also be seen on FIG. 4 that the lever guard 10, which has its handlebar mounting device 42 and first arm segment 26 strategically located between the throttle handle 96 and the front brake master cylinder 94, reduces the presence of an open space between the handlebar 12, the front brake master cylinder 94 and the brake lever 14 to prevent a driver's wrist from being retained in that space in the event of a forward projection of the driver.

According to an embodiment, first arm segment 26 and second arm segment 32 may be made of, without limitation, a metallic material, a composite material and the like, to impart the required high rigidity in spite of their desirable lean profile and light weight.

According to an embodiment, the first arm segment 26 and second arm segment 32 may be made of a material capable of resisting forces applied at about a 30 km/h speed differential between a first motorcyclist and a second motorcyclist for example, or between a first motorcyclist and a careening element 62.

According to an embodiment, the shield member 52 must also be rigid and impact resistant.

According to an embodiment, the shield member 52 may be molded integrally with the second arm segment 32. However, it is to be noted that, according to another embodiment, the shield member 52 is made of a material which includes metal or a highly resistant composite material as a separate and adjustable unit.

It is also to be noted that the lever guard 10 may protect the front brake master cylinder 94, but also protect the gas/oil reservoir (not shown) or reduce the chances of losing the optimized axle of the motorcycle during a competition. Indeed, the high rigidity of the lever guard 10 enables the motorcycle to be supported on the lever guard 10 thus preventing delicate components of the motorcycle from hitting the ground in the event of a crash. In order to provide additional rigidity to the first arm segment 26 and second arm segment 32, ribs 53 are provided (e.g., molded) one of more side thereof.

To meet high mechanical stress requirements, the lever guard 10 has a sturdy construction and can be made from aerospace grade aluminum and carbon fiber reinforced composite material to optimize its strength/weight ratio.

According to another embodiment, the clutch lever (not shown) may also be protected by a lever guard 10 in a similar fashion as the brake lever 14.

According to another embodiment, and referring now to FIGS. 1, 2, 6A, 6B and 6C, there is shown a handlebar extender 100. The handlebar extender 100 includes a bar end extension 102 to be attached to the anchor 22 through the open end 18 (within the hollow portion 16 defined by the handlebar wall 13). The bar end extension 102 is capable of adopting multiple positions between an extended position (FIG. 2) and a retracted position (FIG. 1). The extended position provides an extension 104 externally from the open end 18 of the handlebar 12, thereby allowing the handlebar grip 24 and the throttle slider 20 to be displaced away from the open end 18 on the handlebar wall 13 of the handlebar 12 for providing additional space 106 (corresponding to extension 104) for receiving the lever guard 10 on the handlebar 12.

More particularly, in FIG. 1, there is shown that the handlebar extender 100 is for releasably attachment to the anchor 22 disposed at an end 15 of the handlebar 12 within the hollow portion 16.

According to an embodiment, the bar end extension 102 may include a main portion 108, which defines a hollow space 110, to be at least partially inserted within the hollow portion 16 of the handlebar 12. The bar end extension 102 may further include an lip portion 112 extending from the main portion 108 of the bar end extension 102 for providing an abutment against which the handlebar grip 24 and the throttle slider 20 will come into contact when displaced on the handlebar 14 to cover the extension 104 created by the handlebar extender 100.

It is to be noted that the main portion 108 and the lip portion 112 of the bar end extension 102 may be of a cylindrical shape such as to best suit with the hollow cylindrical shape of the handlebar 12.

According to an embodiment, the handlebar extender 100 may be a rubber expander or any other suitable expander which may be inserted in the hollow portion 16 of a handlebar 12.

It is to be noted that, often, the anchor 22 is normally previously mounted within a handlebar 12. The handlebar extender 100 includes a bar end extension 102 which is for attachment to the anchor 22 to create an extension 104 of about 15 mm, or any other extension needed. The lever guard 10 may then be connected to the handlebar 12 without difficulty. The lever guard 10 may then be positioned between the front brake master cylinder 94/switch 114 and the throttle slider 20/handlebar grip 24,

It is to be noted that the throttle housing 116 may be displaced with the handlebar grip 24 and the throttle slider 20 when the bar end extension 102 is at any position between the unextended position and the extended position. For allowing the reception of the lever guard 10 or any other suitable device on the handlebar 12, the handlebar extender 100 may allow for a displacement of the handlebar grip 24 with the throttle slider 20 of a length of about 15 mm.

Referring now to FIGS. 6A, 6B and 6C, there are shown handlebar extenders 100 in accordance with other embodiments. There are shown different possibilities of connecting or mounting the bar end extension 102 to the anchor 22 or within the hollow portion 16 (or to any other suitable fixed part or portion of the handlebar 12). For example, a retaining wall may be supported by the extremity of the handlebar 12 to create a fixed space of 15 mm.

The handlebar extender 100 may further include a connector 118 for attachment of the anchor 22 and the bar end extension 102. The connector 118 may be a screw or any other suitable connector or fastening device such as to connect the handlebar extender 100 to the handlebar 12 of the motorbike.

It is to be noted that the lever guard 10 and the handlebar extender 100 may fit on any suitable handlebar 12. More particularly, the lever guard 10 and the handlebar extender 100 may fit on a standard handlebar having a 22 mm external diameter.

According to an embodiment, there is provided a ring 55 between the anchor 22 and the bar end extension 102. The ring 55 can be of different lengths according to the extension 104 and conversely the additional space 106 which is required. According to an embodiment, the ring 55 has a given length which corresponds to the extension 104. The ring 55 thereby ensures that the extension 104 that is required is respected. It is envisaged that a lever guard and handlebar extender kit would include rings 55 of different lengths to take into account the varying needs for additional space 106 that would be required on handlebars 12 of different motorcycles.

According to another embodiment, there is provided a method for installing a lever guard 10 on a handlebar 12 having a throttle slider 20, a handlebar grip 24, a switch 114 and a front brake master cylinder 94 installed thereon. The method includes the steps of removing the existing handlebar end cap; installing a handlebar extender 100 at an end 15 of the handlebar 12 to create an extension 104; sliding the throttle slider 20 and the handlebar grip 24 over the extension 104 to create additional space 106 opposite the extension 104; moving the other components installed on the handlebar; and installing a first end 28 of the lever guard 10 on the handlebar 12 after any one of: the switch 114, the front brake master cylinder 94 and the throttle housing 116.

In use, a motorcyclist slides or displaces the handlebar extender 100 away from the handlebar 12 to create an extension 104 and can then slide the throttle slider 20 and the handlebar grip 24 on the extension 104 created to provide additional space 106 to mount a device such as the lever guard 10 described above between one of the switch 114 and the front brake master cylinder 94 (which do not move relative to the handlebar 12) and the throttle housing 116, the throttle slider 20 and the handlebar grip 24.

According to other embodiments (not shown), accessories may be mounted on or near the lever guard 10. The accessories may include a rear view mirror, blinkers, a camera (such as a GoPro® Camera and the like), and a LED fog lamp. It is to be noted that the accessories may be mounted on the first arm segment 26, the second arm segment 32 and/or the shield member 52. The rear view mirror may also be part of the shield member 52.

It is to be noted that the lever guard 10 and the handlebar extender 100 may be positioned on one side only of the motorcycle or on both sides (i.e., one side for the clutch lever and one side for the brake lever).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A lever guard and handlebar extender kit for a motorcycle having a handlebar and a lever mounted thereon, the handlebar comprising a hollow portion having an open end, a handlebar grip and a handlebar end cap mounted within the hollow portion and covering the open end, the kit comprising:
a handlebar extender for replacing the handlebar end cap, the handlebar extender capable of adopting a plurality of positions between a retracted position and an extended position, any one of the plurality of positions providing an extension to the handlebar allowing displacement of the handlebar grip on the handlebar over the extension thereby providing additional space on the handlebar; and
a lever guard for mounting to the handlebar using the additional space and, once mounted, the lever guard extending in front of the lever thereby providing substantial protection from objects coming toward the lever from the front.

2. The kit of claim 1, wherein the handlebar further comprises an anchor installed within the hollow portion and wherein the handlebar extender comprises a bar end extension for adjustable attachment to the anchor.

3. The kit of claim 2, wherein the bar end extension comprises:
a main portion to be at least partially inserted within the hollow portion of the handlebar; and
an lip portion extending from the main portion of the bar end extension and providing an abutment against which the handlebar grip will come into contact when displaced on the handlebar to cover the extension created by the handlebar extender.

4. The kit of claim 3, wherein the handlebar extender further comprises a ring having a given length for installation between the anchor and the bar end extension, the given length corresponding to the extension, the ring thereby ensuring the extension that is required is respected.

5. The kit of claim 3, wherein the main portion of the bar end extension comprise a cylindrical shape which matches a shape of the hollow portion of the handlebar.

6. The kit of claim 3, wherein the handlebar extender further comprises a connector for attachment of the bar end extension to the anchor.

7. The kit of claim 3, wherein at least one of he main portion and the lip portion are made of a rubber material.

8. The kit of claim 1, wherein the extension has a length of about 15 mm.

9. The kit of claim 1, wherein the lever guard comprises:
a first arm segment having a first end and a second end, the first arm segment to be mounted on the handlebar at its first end, the first arm segment extending from the handlebar; and
a second arm segment extending from the second end of the first arm segment in front of the lever, the second arm segment providing the substantial protection from objects coming toward the lever from the front.

10. The kit of claim 9, wherein at least one of the first arm segment and the second arm segment comprise ribs on a surface thereof providing enhanced rigidity.

11. The kit of claim 9, further comprising a shield member mounted on the second arm segment, thereby allowing adjustment of an effective length of the second arm segment.

12. The kit of claim 11, wherein the second arm segment comprises at least one opening about a distal end thereof, the shield member comprises at least one corresponding opening, the kit further comprising at least one connector for removably attaching the shield member about the distal end of the second arm segment using the at least one opening and the at least one corresponding opening.

13. The kit of claim 11, wherein the shield member defines a surface, the surface defining at least one of: a curved shape and at least one projection, thereby reducing possible deflections of the lever under pressure effects caused by one of: wind and a careening element.

14. The kit of claim 11, wherein at least one of: the first arm segment, the second arm segment and the shield member is made from at least one of: a metallic material, a composite material, aerospace grade aluminum and a carbon fiber reinforced composite material.

15. The kit of claim 11, wherein the lever guard further comprises at least one of: a mirror, a lamp, a camera, and a blinker mounted on at least one of: the first arm segment, the second arm segment and the shield member.

16. The kit of claim 9, wherein the lever guard further comprises an articulated joint for articulably joining the first arm segment and the second arm segment, the articulated joint for at least one of: allowing the second arm segment to abut in a rest position to resist forces applied thereto in a direction facing the handlebar and enabling a displacement of the second arm segment relative to the first arm segment in a direction away from the handlebar.

17. The kit of claim 16, wherein the lever guard further comprises a user adjustable stop member assembly for allowing adjustment of a space between the lever and the second arm segment.

18. A method for installing a lever guard on a motorcycle having a handlebar and a lever mounted thereon, the handlebar comprising a hollow portion having an open end and a handlebar grip, the method comprising:
installing a handlebar extender within the hollow portion to create an extension to the handlebar;
sliding the handlebar grip over the extension to create additional space on the handlebar; and
installing the lever guard on the handlebar after the handlebar grip using the additional space.

19. The method of claim 18, further comprising removing a handlebar end cap mounted within the hollow portion prior to installing the handlebar extender.

20. The method of claim 19, further comprising moving other components installed on the handlebar prior to installing the lever guard.
